(19) United States
(12) Patent Application Publication
(10) Pub. No.: US 2019/0347675 A1
(43) Pub. Date: Nov. 14, 2019

(54) SYSTEM AND METHOD FOR USER COHORT VALUE PREDICTION

(71) Applicant: Cognant LLC, Mountain View, CA (US)

(72) Inventors: Wei Yang, San Jose, CA (US); Doug Loyer, San Jose, CA (US); Arun Kejariwal, Fremont, CA (US)

(21) Appl. No.: 16/401,229

(22) Filed: May 2, 2019

Related U.S. Application Data
(60) Provisional application No. 62/671,035, filed on May 14, 2018.

(51) Int. Cl. G06Q 30/02; G06N 5/02; A63F 13/792

(52) U.S. Cl. CPC G06Q 30/0202; A63F 2300/5513; A63F 13/792; G06N 5/02

(57) ABSTRACT

A method, a system, and an article are provided for determining a value for a cohort of users of a client application. An example method includes: obtaining data for a plurality of users of a client application; developing, using the data, a first predictive model to predict a likelihood that a user of the client application will become a payer; developing, using the data, a second predictive model to predict an amount of revenue generated in the client application by the payer; providing the client application to a plurality of new users; using the first predictive model and the second predictive model to predict an amount of revenue generated by a cohort of the new users; and adjusting, based on the predicted revenue for the cohort, a method of acquiring additional users of the client application.

### CROSS-REFERENCE TO RELATED APPLICATIONS

This application claims the benefit of U.S. Provisional Patent Application No. 62/671,035, filed May 14, 2018, the entire contents of which are incorporated by reference herein.

### BACKGROUND

The present disclosure relates to software applications and, in particular, to systems and methods for determining a value of a cohort of users of a software application, such as a software application for a multiplayer online game.

In general, a multiplayer online game can be played by hundreds of thousands or even millions of players who use client devices to interact with a virtual environment for the online game. The players are typically working to accomplish tasks, acquire assets, or achieve a certain score in the online game. Some games require or encourage players to form groups or teams that can play against other players or groups of players. Players can gain a competitive advantage over other players by acquiring skills or assets that other players may not have. Such skills or assets can be acquired in some instances through user activity, transactions, and/or purchases in the multiplayer online game.

### SUMMARY

In general, the subject matter of this disclosure relates to predicting values for cohorts of users of a software application, such as an application for a multiplayer online game. In various examples, one or more predictive models are developed based on data obtained for existing users of the online game. The models can be configured to predict a probability that a new user will make payments (e.g., purchases) in the online game. Users who make such payments can be referred to herein as “payers,” while users who do not make such payments can be referred to herein as “non-payers.” Additionally or alternatively, the models can be configured to predict an amount of revenue that a payer will generate in the online game (e.g., by making purchases). The predicted payer probabilities and the predicted payer revenues for each user in a cohort of users can be used to predict an estimated value of the cohort. The estimated cohort value can be or include, for example, a predicted amount of revenue that will be generated by the cohort in the software application.

In some examples, the multiplayer online game can be provided on a plurality of client devices for a plurality of users, and data related to the game can be obtained for the plurality of users. The data can be used to develop a first predictive model configured to predict a likelihood that a user of the game will become a payer. The data can also be used to develop a second predictive model configured to predict an amount of revenue that will be generated in the game by a payer. The game can be provided to a group of new users, and the first and second models can be used to predict an amount of revenue generated by a cohort of the new users. Based on the predicted revenue for the cohort, adjustments can be made to a method of acquiring additional users of the game. For example, if the models indicate that the cohort of users will generate little revenue, the systems and methods described herein can take corrective action to avoid attracting similar additional new users to the online game and/or to attract a different group of new users that will generate more revenue. Such corrective action can include, for example, adjusting a distribution of content presentations to prospective users of the online game and/or adjusting the items of content presented to the prospective users.

Advantageously, the systems and methods are able to predict values for cohorts based on data collected for a subset of users in the cohort (e.g., a small cohort), shortly after the subset of users begin using the software application (e.g., within a few hours or within a day or two). This can allow the systems and methods to detect low cohort values early and make any necessary corrections to ensure new users of the software application have sufficiently high values. Compared to any previous approaches, the systems and methods are able to make accurate predictions of cohort value much earlier in the user lifecycle. For example, previous approaches could require weeks or months after users begin using the software application before any accurate value data or predictions become available. The systems and methods described herein can make accurate cohort value predictions within just a few hours of users beginning to use the software application.

In one aspect, the subject matter described in this specification relates to a computer-implemented method. The method includes: obtaining data for a plurality of users of a client application; developing, using the data, a first predictive model to predict a likelihood that a user of the client application will become a payer; developing, using the data, a second predictive model to predict an amount of revenue generated in the client application by the payer; providing the client application to a plurality of new users; using the first predictive model and the second predictive model to predict an amount of revenue generated by a cohort of the new users; and adjusting, based on the predicted revenue for the cohort, a method of acquiring additional users of the client application.

In certain examples, the data can include a record of user activity from before and/or after installation of the client application. The data can include a user characteristic and/or a client device characteristic. The client application can be or include a multiplayer online game. Using the first predictive model can include: providing, as input to the first predictive model, one or more features for each new user in the plurality of new users, wherein the one or more features include an indication of the new user's activity from before and/or after the new user began using the client application; and receiving, as output from the first predictive model, a predicted likelihood that each new user will be a payer in the client application. Using the second predictive model can include: providing, as input to the second predictive model, one or more features for each new user in the plurality of new users, wherein the one or more features for each new user include an indication of the new user's activity from before and/or after the new user began using the client application; and receiving, as output from the second predictive model, a predicted amount of revenue generated by each new user who becomes a payer in the client application.

In various implementations, using the first predictive model and the second predictive model can include: combining predictions from the first predictive model and the second predictive model to predict an amount of revenue generated by each new user who becomes a payer in the client application; identifying from among the plurality of new users a subset of new users who belong to the cohort; and determining a total predicted revenue generated by the subset of new users. The predicted amount of revenue generated by the cohort can be or include a prediction for an initial time after the cohort began using the client application. Using the first predictive model and the second predictive model can include extrapolating the prediction for the initial time to a later time using one or more multipliers. The method of acquiring additional users can include presenting content related to the client application to a set of prospective additional users.

In another aspect, the subject matter described in this specification relates to a system having one or more computer processors programmed to perform operations including: obtaining data for a plurality of users of a client application; developing, using the data, a first predictive model to predict a likelihood that a user of the client application will become a payer; developing, using the data, a second predictive model to predict an amount of revenue generated in the client application by the payer; providing the client application to a plurality of new users; using the first predictive model and the second predictive model to predict an amount of revenue generated by a cohort of the new users; and adjusting, based on the predicted revenue for the cohort, a method of acquiring additional users of the client application.

In some examples, the data can include a record of user activity from before and/or after installation of the client application. The data can include a user characteristic and/or a client device characteristic. The client application can be or include a multiplayer online game. Using the first predictive model can include: providing, as input to the first predictive model, one or more features for each new user in the plurality of new users, wherein the one or more features include an indication of the new user's activity from before and/or after the new user began using the client application; and receiving, as output from the first predictive model, a predicted likelihood that each new user will be a payer in the client application. Using the second predictive model can include: providing, as input to the second predictive model, one or more features for each new user in the plurality of new users, wherein the one or more features for each new user include an indication of the new user's activity from before and/or after the new user began using the client application; and receiving, as output from the second predictive model, a predicted amount of revenue generated by each new user who becomes a payer in the client application.

In certain implementations, using the first predictive model and the second predictive model can include: combining predictions from the first predictive model and the second predictive model to predict an amount of revenue generated by each new user who becomes a payer in the client application; identifying from among the plurality of new users a subset of new users who belong to the cohort; and determining a total predicted revenue generated by the subset of new users. The predicted amount of revenue generated by the cohort can be or include a prediction for an initial time after the cohort began using the client application. Using the first predictive model and the second predictive model can include extrapolating the prediction for the initial time to a later time using one or more multipliers. The method of acquiring additional users can include presenting content related to the client application to a set of prospective additional users.

In another aspect, the subject matter described in this specification relates to an article. The article includes a non-transitory computer-readable medium having instructions stored thereon that, when executed by one or more computer processors, cause the computer processors to perform operations including: obtaining data for a plurality of users of a client application; developing, using the data, a first predictive model to predict a likelihood that a user of the client application will become a payer; developing, using the data, a second predictive model to predict an amount of revenue generated in the client application by the payer; providing the client application to a plurality of new users; using the first predictive model and the second predictive model to predict an amount of revenue generated by a cohort of the new users; and adjusting, based on the predicted revenue for the cohort, a method of acquiring additional users of the client application.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for predicting a value of a user cohort in a software application.

FIGS. 2 and 3 are schematic data flow diagrams of an example system for predicting a value of a user cohort in a software application.

FIG. 4 is a flowchart of an example method of predicting a value of a user cohort in a software application.

### DETAILED DESCRIPTION

In general, the systems and methods described herein can be used to predict a value for a cohort of users of a software application. In certain examples, a “cohort” can be a group of users who share certain commonalties, such as residing in a common geographical location (e.g., country), accessing or using the same publishers (e.g., websites), using the same or similar client devices, and/or sharing one or more demographic features (e.g., age and/or gender). For example, a cohort of users can be all users who reside in a particular geographical region (e.g., a country), all users who installed or began using the software application in response to one or more items of content presented by a particular publisher, all users who installed or began using the software application in response to one or more particular items of content, all users who utilize a particular client device, all users who utilize or access the same or similar IP address, and/or any combination of such user features or other user features. A “small cohort” can be, for example, two or more users from the same cohort during a certain period of time. A cohort can be or include multiple instances of small cohorts. In some instances, for example, data can be collected for a small cohort and used to predict a value for the small cohort and/or an entire cohort to which the small cohort belongs. In certain examples, the “lifetime value” (or “LTV”) of a user can be or include an amount of revenue generated by the user in the software application during the user's lifetime or entire period of use of the software application. A “publisher” can be a website, a software application, or other site or service that presents or publishes content to users. A “publisher tier” can be a group of publishers that shares similar qualities, for example, based on the content presented by the publishers or the audience reached by the publishers.

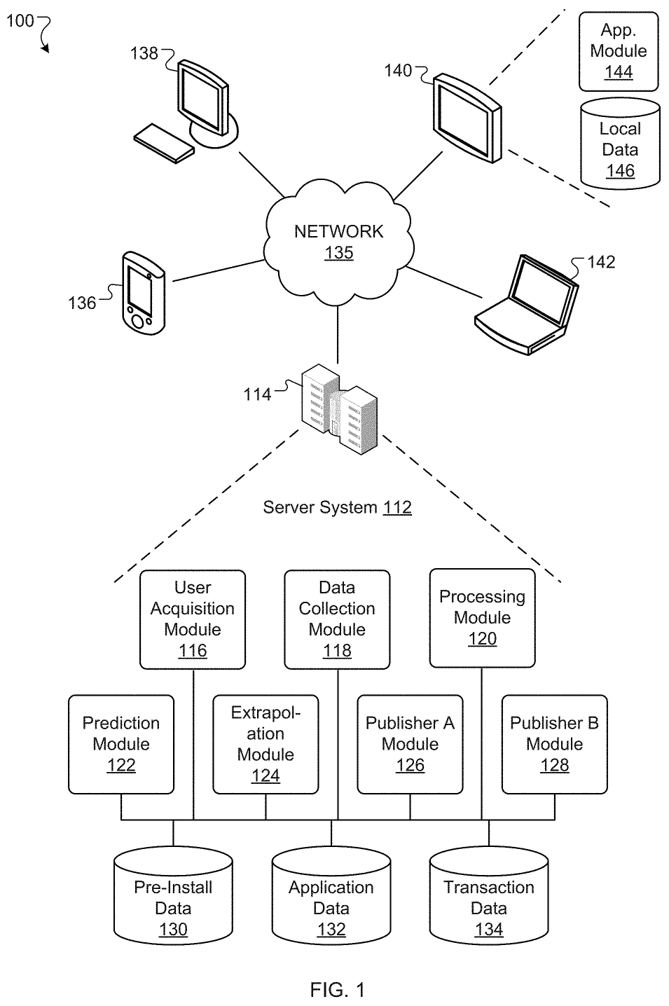

FIG. 1 illustrates an example system 100 for predicting a value of a user cohort in a software application. A server system 112 provides functionality for collecting, processing, and analyzing data associated with users and cohorts of users of the software application. The server system 112 includes software components and databases that can be deployed at one or more data centers 114 in one or more geographic locations, for example. In certain instances, the server system 112 is, includes, or utilizes a content delivery network (CDN). The server system 112 software components can include a user acquisition module 116, a data collection module 118, a processing module 120, a prediction module 122, an extrapolation module 124, a publisher A module 126, and a publisher B module 128. The software components can include subcomponents that can execute on the same or on different individual data processing apparatus. The server system 112 databases can include a pre-install data 130 database, an application data 132 database, and a transaction data 134 database. The databases can reside in one or more physical storage systems. The software components and data will be further described below.

A software application (also referred to herein as a “client application”), such as, for example, a web-based application, can be provided as an end-user application to allow users to interact with the server system 112. The software application can relate to and/or provide a wide variety of functions and information, including, for example, entertainment (e.g., a game, music, videos, etc.), business (e.g., word processing, accounting, spreadsheets, etc.), news, weather, finance, sports, etc. In preferred implementations, the software application provides a computer game, such as a multiplayer online game. The software application or components thereof can be accessed through a network 135 (e.g., the Internet) by users of client devices, such as a smart phone 136, a personal computer 138, a tablet computer 140, and a laptop computer 142. Other client devices are possible. In alternative examples, the pre-install data 130 database, the application data 132 database, the transaction data 134 database, or any portions thereof can be stored on one or more client devices. Additionally or alternatively, software components for the system 100 (e.g., the user acquisition module 116, the data collection module 118, the processing module 120, the prediction module 122, the extrapolation module 124, the publisher A module 126, and the publisher B module 128) or any portions thereof can reside on or be used to perform operations on one or more client devices.

Additionally or alternatively, each client device in the system 100 can utilize or include software components and databases for the software application. The software components on the client devices can include an application module 144, which can implement the software application on each client device. The databases on the client devices can include a local data 146 database, which can store data for the software application and exchange the data with the application module 144 and/or with other software components for the system 100, such as the data collection module 118. The data stored on the local data 146 database can include, for example, user data, user history data, user transaction data, image data, video data, and/or any other data used or generated by the system 100. While the application module 144 and the local data 146 database are depicted as being associated with the tablet computer 140, it is understood that other client devices (e.g., the smart phone 136, the personal computer 138, and/or the laptop computer 142) can include the application module 144, the local data 146 database, or any portions thereof.

FIG. 1 depicts the user acquisition module 116, the data collection module 118, the processing module 120, the prediction module 122, the extrapolation module 124, the publisher A module 126, and the publisher B module 128 as being able to communicate with the pre-install data 130 database, the application data 132 database, and the transaction data 134 database. The pre-install data 130 database generally includes data related to user characteristics (e.g., geographical location, gender, age, and/or other demographic information), client device characteristics (e.g., device model, device type, platform, and/or operating system), and/or a history of activity that existed or occurred prior to installation of the software application on the client devices. The history of activity can include, for example, information related to: content presentations on the client devices, user interactions with the content presentations, and publishers of the content presentations (e.g., websites and/or other applications). In general, the history can include information about how each user first installed and began using the software application. For example, the history of content presentations can be or include, for example, data summarizing each content presentation and any user interactions with the content presentations. Such data can include, for example, a device identifier, a publisher name and/or publisher identifier, a timestamp for a presentation time, a timestamp for a user interaction time, and/or similar data for each content presentation. The application data 132 database generally includes a history of user interactions with the software application. The user interactions can include, for example, user inputs to the client devices, user messages, user advancements (e.g., in an online game), user engagements with other users, and/or user assets. Data in the application data 132 database can be updated periodically, such as every minute, hour, or day. The transaction data 134 database generally includes a history of user transactions made in or with the software application. Such transactions can include, for example, user purchases, user sales, or similar activity, along with values (e.g., dollar amounts) for the transactions. In the context of an online game, transaction data can include a record of any purchases made by players, for example, to acquire virtual items, additional lives, new game features, or some other advantage.

In various examples, the user acquisition module 116 can be used to acquire new users of the software application. New users can be acquired, for example, by presenting digital content related to the software application on client devices of prospective users. In some instances, the digital content can be or include images, videos, audio, computer games, text, messages, offers, and any combination thereof. The digital content can encourage prospective users to download, install, and/or begin using the software application. The prospective users can interact with the digital content and be presented with opportunities to install and/or use the software application. In a typical example, the user acquisition module 116 can utilize one or more publishers (e.g., websites or other software applications) to present the digital content. The one or more publishers can be or include the publisher A module 126 and/or the publisher B module 128.

The data collection module 118 is generally configured to collect data that the system 100 uses to predict the value of users and user cohorts. The data collection module 118 can obtain data related to digital content presentations on client devices and any user interactions with the digital content. Additionally or alternatively, the data collection module 118 can obtain data related to user characteristics (e.g., geographical location, gender, age, and/or other demographic information), client device characteristics (e.g., device model, device type, platform, and/or operating system), and/or any user interactions or transactions with the software application. The data collection module 118 can provide the data to the pre-install data 130 database, the application data 132 database, and/or the transaction data 134 database. The data can be shared with other system components as described herein. In various examples, the data collection module 118 can utilize or include an attribution service provider. The attribution service provider can receive data or information from publishers related to the presentation of content and user actions in response to the content. The attribution service provider can determine, based on the information received, how to attribute the user actions to individual publishers.

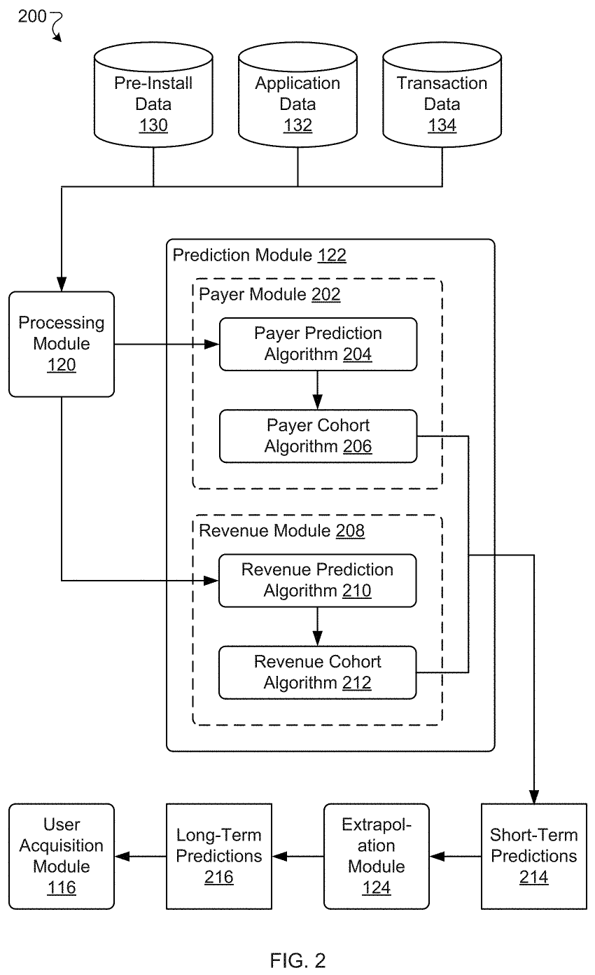

FIG. 2 illustrates an example system 200 in which the processing module 120 and the prediction module 122 are used to predict lifetime values for cohorts of users of the software application. To begin, data from the pre-install data 130 database, the application data 132 database, and/or the transaction data 134 database is provided to the processing module 120 for a set of users of the software application. The processing module 120 can preprocess the data to generate a set of processed data that can be used to train one or more predictive models (e.g., in the prediction module 122) and/or can be used as input to the one or more predictive models. The processing module 120 can perform data cleansing, user vectorization, and/or data merging, though other data processing can be performed. The data cleansing can include missing data imputation, one-hot encoding, or similar techniques. The cleansed data is preferably numerical and has no null values. The user vectorization can include transforming application data and/or transaction data from a daily or hourly level to a user level, such that a single vector of data can be obtained for each user. The data merging can include joining the cleansed and vectorized data to form one or more matrices in which each row represents a user (e.g., for predicting payer probability) and/or each row represents a payer (e.g., for predicting revenue per payer), as described herein.

Next, the processed data from the processing module 120 can be provided to the prediction module 122, which can include or utilize one or more predictive models. The processed data can be used by the prediction module 122 to train the predictive models. Additionally or alternatively, the processed data can be used as input to the predictive models, which can provide predictions of user cohort value for the software application. In the depicted example, the prediction module 122 includes a payer module 202 that utilizes a payer prediction algorithm 204 or other predictive model for predicting the likelihood that a user (e.g., a new or recently acquired user) will be a payer in the software application. This likelihood can be referred to herein as a “payer probability.” The payer module 202 can also utilize a payer cohort algorithm 206 for determining the payer probability distribution for a cohort of users. The payer probability distribution can indicate, for example, how many users in the cohort have a payer probability of 10%, 50%, 90%, or any other payer probability of interest, from 0% to 100%. The prediction module 122 also includes a revenue module 208 that utilizes a revenue prediction algorithm 210 or other predictive model for predicting an amount of revenue that each payer will generate in the software application. This amount of revenue can be referred to herein as a “payer revenue.” The revenue module 208 can also utilize a revenue cohort algorithm 212 for determining the payer revenue distribution for a cohort of users. The payer revenue distribution can indicate, for example, how much revenue each payer in the cohort is expected to generate in the software application. The predictions from the payer module 202 and the revenue module 208 can be combined and provided as output from the prediction module. The output can be or include a predicted amount of revenue generated by a cohort of users in the software application. In preferred examples, the predictive models used by the payer module 202 can be separate and independent from the predictive models used by the revenue module 208.

Table 1 presents results for an example involving 10 users (users 1-10) from two small cohorts (A and B). The predicted payer probability values (e.g., obtained from the payer prediction algorithm 204) are presented in the third column of this table, and the predicted payer revenue values (e.g., obtained from the revenue prediction algorithm 210) are presented in the fifth column of the table. The fourth column provides an indication of whether or not each user has been identified as being a payer. In this example, users having a pay probability higher than 0.5 (50%) can be identified as being payers.

TABLE 1
Example results for two small cohorts of users.

| | Small | Payer | Payer? | Payer |
|---|---|---|---|---|
| User | Cohort | Probability | (Yes/No) | Revenue |
| 1 | A | 0.4 | 0 | |
| 2 | A | 0.3 | 0 | |
| 3 | A | 0.7 | 1 | $107 |
| 4 | A | 0.2 | 0 | |
| 5 | A | 0.9 | 1 | $35 |
| 6 | A | 0.1 | 0 | |
| 7 | B | 0.6 | 1 | $532 |
| 8 | B | 0.4 | 0 | |
| 9 | B | 0.2 | 0 | |
| 10 | B | 0.3 | 0 | |

To predict cohort values, the payer probability and payer revenue values can be aggregated for a portion or all of the users in the cohort. For example, the estimated payer ratio and estimated revenue per payer for a cohort can be multiplied together to obtain a predicted revenue or value for the cohort as follows:

Cohort Value=N_{C}*payer ratio*revenue per payer, (1)

where N_{C} is the number of users in the cohort, payer ratio is the ratio of the number of payers to the number of users in the cohort (e.g., a fraction of users in the cohort who are payers), and revenue is the amount of revenue generated by each payer in the cohort (e.g., on average). Alternatively or additionally, a number of payers in a cohort can be determined by aggregating the payer probabilities for the users in the cohort. Referring again to Table 1, for example, the number of payers in small cohort A can be a sum of the payer probabilities for small cohort A (e.g., 0.4+0.3+0.7+0.2+0.9+0.1=2.6 payers) Likewise, the amount of revenue generated by small cohort A can be a sum of the predicted payer revenue values for small cohort A (e.g., $107+$35=$142). In some implementations, a predicted amount of revenue generated by a cohort can be determined by calculating a sum of the product of payer probability and payer revenue for each payer in the cohort. For small cohort A, for example, the predicted amount of revenue can be determined from (0.7×$107)+(0.9×$35)=$106. The cohort value can be a predicted amount of revenue generated by the cohort within the time period (e.g., 7 days or 30 days). Long-term multipliers can be used to predict cohort values for longer time periods, as described herein.

In certain instances, there can be many more users than payers in the software application and/or in a typical cohort. Consequently, the amount of preprocessed training data for the payer module 202 can be several orders of magnitude greater than the amount of preprocessed training data for the revenue module 208. For this reason, the preprocessed training data for the payer module 202 can be maintained in a big matrix (where each row represents a user), while the preprocessed training data for the revenue module 208 can be maintained in a smaller matrix (where each row represents a payer).

In various implementations, the output from the prediction module 122 can be or include short-term predictions 214 for user cohort value or revenue. The short-term predictions 214 can include, for example, a predicted amount of revenue generated by one or more cohorts or small cohorts of users. The short-term predictions 214 can correspond to a short time period (e.g., one week, one month, or other time period) after users in a cohort or small cohort first installed or began using the software application. For example, the prediction module 122 can predict an amount of revenue that a small cohort of new users will generate in the software application within one week or one month of first beginning to use the software application.

Next, the short-term predictions 214 can be extrapolated to generate long-term predictions 216 using the extrapolation module 124. The long-term predictions 216 can include, for example, a predicted amount of revenue that a cohort of users will generate in the software application within the long period of time after first using the software application. To generate the long-term predictions 216 from the short-term predictions 214, the extrapolation module 124 can utilize one or more multipliers. The multipliers can be determined, for example, based on historical data for one or more parameters (e.g., in the pre-install data 130 database, the application data 132 database, and/or the transaction data 134 database), such as geographical location (e.g., country), device type, platform (e.g., iOS or ANDROID), publisher, etc. The multipliers can be relatively stable in accordance with the nature of the software application. The historical data may indicate, for example, that long-term values are 50% higher than short-term values for a given parameter (e.g., geographical location) or combination of parameters. In such a case, the long-term predictions 216 can be proportional to the short-term predictions 214. Alternatively or additionally, the extrapolation module 124 can determine that the long-term predictions 216 may not be proportional to the short-term predictions 214. In that case, the extrapolation module 124 can use a different mathematical relationship or functional form (e.g., an exponential function or a polynomial) to derive the long-term predictions 216 from the short-term predictions 214. The mathematical relationship can include one or more parameters from the pre-install data 130 database, the application data 132 database, and/or the transaction data 134 database (e.g., as independent variables).

Next, the user acquisition module 116 can be configured to acquire new users of the software application based on the short-term predictions 214 and/or the long-term predictions 216. This can be achieved, for example, by targeting different types of prospective users and/or adjusting content presentations on client devices of prospective users. For example, the user acquisition module 116 can determine that a new cohort of users from a certain geographical location (e.g., a country or state) will have low lifetime values. In response, the user acquisition module 116 can stop targeting additional prospective users from that geographical location and/or can begin targeting additional prospective users in a different geographical location. Additionally or alternatively, the user acquisition module 116 can determine that a new cohort of users with a low lifetime value began using the software application after being exposed to a particular item of content (e.g., a video showing the software application). In such a case, the user acquisition module 116 can make adjustments to the content being presented to prospective users. Such adjustments can include, for example, stopping or decreasing the presentation of one or more items of content, beginning or increasing the presentation of one or more items of content, and/or revising one or more items of content. Additionally or alternatively, the user acquisition module 116 can determine that a new cohort of users with a low lifetime value was introduced to the software application through content presented by a particular publisher (e.g., the publisher A module 126). In such a case, the user acquisition module 116 can stop utilizing that publisher to present content to prospective users in the publisher's audience.

Advantageously, by determining values for user cohorts in the software application, the systems and methods described herein are able to take corrective action to ensure that any additional new users will have sufficient lifetime values. For example, the systems and methods can take action to ensure that additional new users will, at least on average, be payers and/or generate a desired or threshold level of revenue for the software application. The collection of predictive models, described herein, can allow cohort value predictions to be made soon after user acquisition and to be updated as the user interacts with the software application and additional user data is obtained, over time. Additionally or alternatively, the cohort value predictions can be aggregated by any desired parameter or dimension, such as publisher, geographical location, and the like, thereby allowing cohorts and cohort values to be evaluated for each dimension. This can allow the user acquisition module 116 to take immediate, corrective action, as needed, based on predicted cohort values associated with each dimension.

In some examples, the model predictions can be used as feedback to further train the models and/or to take corrective action when new user cohorts have low value predictions. In such a case, the approach can utilize a control mechanism by comparing the predicted cohort value with a target cohort value. Based on any error identified in the comparison, adjustments can be made to the user acquisition process (e.g., by the user acquisition module 116). For example, when the predicted cohort value is far below the target cohort value, the user acquisition module 116 can take corrective action in an effort to acquire different or additional types of users that have higher lifetime values. Such comparisons can be made each time the system is run (e.g., every hour, every 6 hours, every 12 hours, or every day) and new model predictions become available.

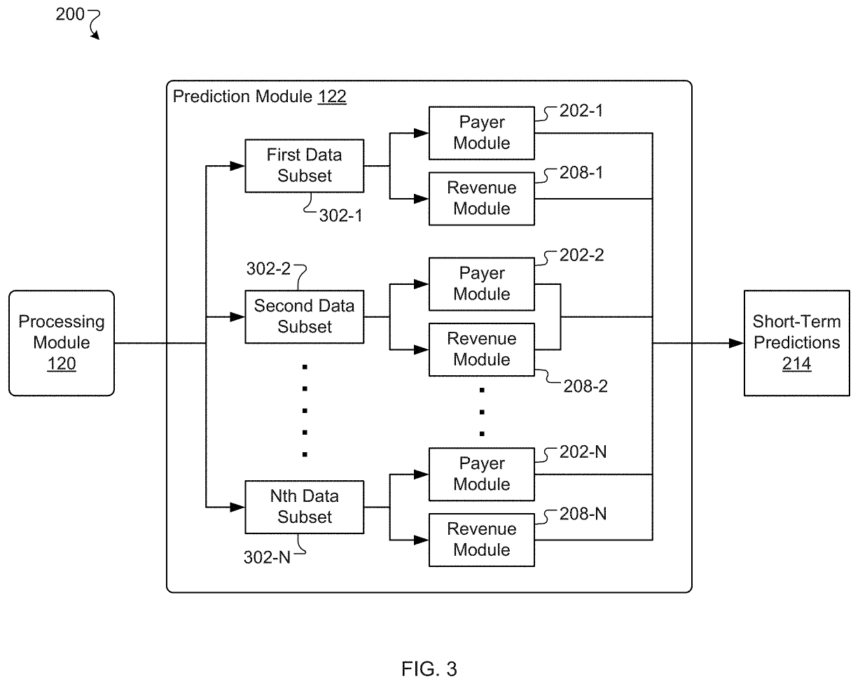

Referring to FIG. 3, in some examples, the prediction module 122 can include a collection of predictive models for predicting (i) the payer probability (e.g., a likelihood that users will be payers for the software application) and (ii) a payer revenue (e.g., amount of revenue generated by payers in the software application). The processed data from the processing module 120 can be divided into subsets of data 302 in which each subset can correspond to, for example, a distinct user age, where user age is or represents a length of time since a user first installed or began using the software application. For example, a user who installed or began using the software application yesterday can have a user age of one day. In preferred examples, processed data for users having a first user age (e.g., one day) can be added to a first subset of data 302-1, processed data for users having a second user age (e.g., two days) can be added to a second subset of data 302-2, and so on, to form a total of N subsets of data, where N can be any integer greater than one. For example, an Nth subset of data 302-N can include processed data 212 for users having a user age of N days. In some instances, user age can be measured in hours, days, weeks, months, or other units of time.

Each subset of data 302 can then be provided as input to a respective payer module 202 and a respective revenue module 208, which can utilize or include the payer prediction algorithm 204, the payer cohort algorithm 206, the revenue prediction algorithm 210, and the revenue cohort algorithm 212, respectively, as described herein. The first subset of data 302-1 can be provided as input to the payer module 202-1 and the revenue module 208-1, which can then make predictions based on the input. Similar predictions can be made by the other instances of the payer module 202 and the revenue module 208, using the other subsets of data 302 as input. The collection of models utilized by the payer module 202 and the revenue module 208 described herein can be referred to as a chain of predictive models.

In preferred examples, each predictive model can be tailored to make predictions for a specific user age. For example, the payer module 202-1 and the revenue module 208-1 can be tailored to make predictions for users having a user age corresponding to the first subset of data 302-1 (e.g., a user age of one day). Likewise, the payer module 202-2 and the revenue module 208-2 can be tailored to make predictions for users having a user age corresponding to the second subset of data 302-2 (e.g., a user age of two days). As a user advances in age, data for the user can be assigned to a new subset of data 302, which can be processed by a new payer module 202 and/or a new revenue module 208.

In various examples, each payer module 202 can be configured to predict a probability that a user, who is not currently a payer, will become a payer by the time the user reaches a target user age (e.g., one week or one month). For example, the payer module 202-1 can be used to predict the probability that a user having a user age of one day will become a payer by the time the user reaches a user age of one week. When the user is not already a payer, there is generally no transaction data available for the user (e.g., in the transaction data 134 database), so the payer module 202-1 can make the prediction based on any available data for the user in the pre-install data 130 database and/or in the application data 132 database. Likewise, the payer module 202-2 can be used to predict the probability that a user having a user age of two days will become a payer by the time the user reaches the user age of one week. Additional payer modules 202 can be used to predict payer probability as the user advances in age. In general, as more application data is collected for the user, the models can receive more information as input and can provide more accurate predictions. For example, payer module 202-N can make predictions based on N days of application data and generally will be more accurate (e.g., based on root-mean-square error) than payer module 202-1, which may make predictions based on one day of data.

In some instances, a user may become a payer by making a transaction in the software application. In that case, the payer probability for the user is already known (e.g., 100%), and there is generally no need to use the payer modules 202 for that specific user. Each user can be assigned a value indicating whether the user is (or is predicted to become) a payer (e.g., payer value=1) or a non-payer (e.g., payer value=0).

Likewise, each revenue module 208 can be configured to predict an amount of revenue generated by a user in the software application by the time the user reaches the target user age (e.g., one week or one month). For example, the revenue module 208-1 can be used to predict the amount of revenue generated by a user, having a user age of one day, by the time the user reaches a target user age of one week. The revenue module 208-1 can make the prediction based on any available data for the user in the pre-install data 130 database, the application data 132 database, and/or the transaction data 134 database for the user. Similarly, the revenue module 208-2 can be used to predict the amount of revenue generated by a user, having a user age of two days, by the time the user reaches the target user age of one week. Additional revenue modules 208 can be used to predict revenue as the user advances in age. In general, as more application data 206 and/or transaction data 208 is collected for the user, the models can receive more information as input and can provide more accurate predictions. For example, revenue module 208-N can make predictions based on N days of application data 206 and/or transaction data 208 and generally will be more accurate (e.g., based on root-mean-square error) than revenue module 208-1, which may make predictions based on one day of data.

In various examples, when there are N payer modules 202 and/or N revenue modules 208, the target user age can correspond to a time period of N+1. For example, when N=6, there can be six payer modules 202 and six revenue modules 208 used to make predictions for user ages of 1, 2, 3, 4, 5, and 6 (e.g., in days). The target user age in this example can be N+1=7 (e.g., 7 days). The output from each payer module 202 and each revenue module 208 can be collected in a single batch of model predictions and can be provided as the short-term predictions 214.

In general, the predictive models used by the payer modules 202 and the revenue modules 208 can perform regression or classification and are preferably tree-based, though other suitable models can be used. Tree-based learning algorithms are generally robust to outliers. Tree-based methods can split a feature space into distinct and non-overlapping regions, and the splits can be performed based on information gain. The approach can require relatively little data preparation compared to other algorithms. In a preferred approach, gradient boosting trees can combine weak learners (e.g., decision trees) in an additive and iterative manner, with a model in each iteration correcting a predecessor model. The payer modules 202 (e.g., the payer prediction algorithm 204 or the payer cohort algorithm 206) and/or the revenue modules 208 (e.g., the revenue prediction algorithm 210 or the revenue cohort algorithm 212) can be based on or can utilize, for example, gradient boosting trees, neural networks, and/or random forest, though other regression models or classifiers can be used. In preferred implementations, models based on gradient boosting trees can produce cohort value predictions that generalize well. The predictions can be used to guide future content presentations based on limited user data (e.g., from a small cohort).

Referring to FIGS. 2 and 3, the system 200 can utilize data from the pre-install data 130 database, the application data 132 database, and/or the transaction data 134 database as input. The pre-install data can include features such as, for example, install platform (e.g., iOS or ANDROID), device model (e.g., iPhone 6), device country code, Internet Protocol (IP) country code, and the like. The pre-install data can capture a user profile from before installation of the software application. The predictive models can weigh such data more heavily for new users and less heavily for older users. The application data can capture a user profile based on user interactions with the software application. For purposes of illustration and not limitation, when the software application is for a computer game, such as a multiplayer online game, the application data can include one or more game features including, but not limited to, total power (e.g., a measure of player influence over other players), user level, research complete (e.g., a measure of user skill level), and/or play minutes (e.g., a total time spent playing the game). As user age increases, the predictive models can weigh the application data more heavily, relative to the pre-install data. The application data can become, for example, the most indicative factor for determining a user's future engagement in the software application, as well as the user's propensity to become a payer and/or generate revenue. The transaction data can provide features that are unique to revenue prediction models and/or can form a time series of transactions for a user. Such features are important for older users who have been using the application for a certain time period. The system 200 can provide feedback on the selection of the above features. For example, the system 200 can compare model predictions with actual payer and revenue determinations. Additionally or alternatively, the predictive models can be retrained to reduce errors in model predictions. This can allow the predictive models to learn the influences of the various input data types and evolve over time.

In some instances, for example, the predictive models described herein can be refined over time to improve prediction accuracy. The models can receive data for a new small cohort of users and, based on the data, the can predict a future value for the small cohort. The future value can be or include, for example, a predicted amount of revenue generated by the small cohort of users when the users reach a target age in the software application (e.g., 7 days or 30 days). When the small cohort of users reaches the target age, an actual value for the small cohort can be determined and compared with the model predictions. Such comparisons can be made, for example, by calculating an error or difference (e.g., a Brier score) between the actual value and the predicted value. The predictive models can then be refined or adjusted (e.g., retrained) in an effort to improve prediction accuracy. This way, when a similar small cohort of users begins using the software application, the predictive models can make a more accurate prediction of the future value of the small cohort.

While certain implementations for the prediction module 122 can utilize multiple predictive models to predict both payer probability and revenue (e.g., in the payer module 202 and the revenue module 208), alternative implementations can utilize a single model to make such predictions. For example, the prediction module 122 can utilize a single predictive model to predict (i) the probability that a user will be a payer and/or (ii) the amount of revenue generated by the user. In such an instance, the single predictive model can receive input data for all user ages and provide the payer and revenue predictions for each user and/or for each user age group. For example, like the multiple predictive models described herein, the single predictive model can make separate payer and revenue predictions for each user age group. The input data for the single predictive model can include the pre-install data, the application data, and/or the transaction data for each user, as well as the user age of each user.

In various examples, it can be desirable when training the predictive models described herein to utilize a degree of underfitting between the models and the training data. The underfitting can be achieved, for example, by limiting game features or other application features to the first few hours of user age (e.g., the first 2, 3, or 4 hours). Alternatively or additionally, the training data (e.g., for the revenue prediction algorithm 210) can include pre-install data (e.g., from the pre-install data 130 database) but little or no application data (e.g., from the application data 132 database) or transaction data (e.g., from the transaction data 134 database). In some examples, underfitting can be achieved by using more early funnel features (e.g., from the pre-install data 130 database) and/or from application features (e.g., from the application data 132 database) from early user ages (e.g., within the first few hours or days), rather than deeper or late funnel features (e.g., from the application data 132 database or the transaction data 134 database) from later user ages (e.g., after several hours or days). For example, the training data can be or include more than about 75% or 90% early funnel feature data. Underfitting can be achieved by using training data that includes a limited number, type, and/or quantity of pre-install features and/or application features. Underfitting can involve training a model using one error term for each desired cohort. In some implementations, underfitting can be controlled using a Brier score or other score that measures a difference between actual values and predicted values. For example, the Brier score can have a value of 0 when the actual values match the predicted values or a value of 1 when there is little or no agreement between the actual values and the predicted values. Optimal underfitting can be achieved, for example, when the Brier score is about 0.05, 0.1, 0.25, 0.5, 0.75, 0.9, or 0.95.

In general, underfitting the predictive models to the training data can help the predictive models generalize better, for example, by accurately capturing underlying trends and/or by not being too heavily influenced by inaccuracies in training data. Once trained, the underfit models can be used to make predictions for new or different cohorts that may not have been considered directly during training. For example, groups of users can be aggregated to obtain predictions for new cohorts that were not considered separately or expressly during the training process. Alternatively or additionally, when more training data later becomes available, a model can be retrained to consider a new small cohort that was not considered during previous training. This can involve adding a new error term for the new small cohort.

In various examples, payer probability and payer revenue can be predicted using the systems and methods described herein, which can be trained and/or configured to make predictions based on features or signals at the cohort-level. These cohort-level payer probability predictions and payer revenue predictions can be referred to herein as P₁ and R₁, respectively. Additionally or alternatively, payer probability and payer revenue can be predicted using predictive models that are trained and/or configured to make predictions based on features or signals at the user-level. These user-level payer probability predictions and payer revenue predictions can be referred to herein as P₂ and R₂, respectively. In various examples, the predictive models for making user-level predictions may differ from the predictive models for making cohort-level predictions in that the user-level models may use less underfitting (e.g., little or no underfitting). Additionally or alternatively, the user-level models may not be configured for comparing actual data for previous cohorts with predictions for new cohorts, as described herein.

Referring again to FIG. 2, the payer module 202 can be used to predict payer probability for a collection of users. The payer probability can be or include a predicted likelihood that a user will become a payer in the software application by a target user age (e.g., 7, 14, or 30 days, or more). In some examples, the system 200 can make predictions based on processed data for some or all of the users who installed the software application within a given time period (e.g., the last 30 days). The models used to make the predictions (e.g., in the payer prediction algorithm 204 and/or the payer cohort algorithm 206) are preferably tree-based and can have custom parameters configured for making the intended predictions. While the system 200 can make a P₁ prediction for a user based on the user's game behavior within the first three hours, the system 200 can make more accurate predictions by leveraging additional game behavior after the first three hours. Predicted payer probability for a user can be 0 or 1 (or any intermediate value) based on the processed data for the user.

In some instances, P₂ can differ from the actual payer probability more than P₁, for example, because prediction accuracy for an individual user can be ill-defined. In general, all predictions (e.g., either P₁ or P₂) for an individual user can have errors or can be “wrong.” Prediction accuracy can be defined in terms of area under curve (AUC) or log loss, when comparing predictions and actual values for a set of users. In contrast, measured over all users, P₂ can be significantly more accurate than P₁, in terms of log loss, AUC, calibration curves, etc.

In a cohort value scenario, underfitting can be deliberately pursued for individual user payer predictions. Observed payer probability at a user age of seven days can be considered to be a suitable prediction for an individual user's payer probability. Due to the nature of small sample size, in most cases, the average of payer probability for all users in one small cohort can differ from the average of payer probability for all users in another small cohort during another period of time. Although P₂ can be a better approximation of payer probability, P₂ can be inferior to P₁ when the task is to estimate the cohort payer ratio (e.g., the ratio of the number of payers in a cohort to the number of users in the cohort). Although current P₁ can be based on game behavior within the first three hours for a user, P₁ can be applied to any other set of features, preferably by introducing an optimal amount of overfitting to the model, such that the average of P₁ can generalize well for the cohort.

Overfitting can be introduced, for example, by training the predictive models with additional application data (e.g., from the application data 132 database) and/or transaction data (e.g., from the transaction data 134 database). In one preferred example, the predictive models in the payer module 202 and/or the revenue module 208 can be trained using application data and/or transaction data for user ages up to about 3 hours (e.g., data from the first 3 hours of user interaction with the software application). Overfitting can be introduced by training the models using additional application data and/or transaction data, for example, for user ages up to about 5 hours, 10 hours, 24 hours, or more, with higher ages resulting in more training data and more overfitting. Various amounts of overfitting can be explored (e.g., using trial and error) in an effort to optimize model performance.

Likewise, the revenue module 208 can be used to predict the revenue generated by each payer by an age of seven days. Such predictions can be made based on data from the pre-install data 130 database for some or all payers who installed the software application within the last 30 days. The models used to make the predictions (e.g., in the revenue prediction algorithm 210 and/or the revenue cohort algorithm 212) are preferably tree-based and can have custom parameters configured for making the intended predictions. While the system 200 can make an R₁ prediction for a payer based on the payer's pre-install data, the system 200 can make a more accurate R₂ prediction by leveraging additional game behavior of the payer (e.g., using data from the application data 132 database). Payer revenue can be based on observations. For an individual payer, R₂ might differ from the actual payer revenue more than R₁. In contrast, measured over all payers, R₂ can be significantly more accurate than R₁, in terms of root mean square error, calibration curves, etc.

In the cohort value scenario, underfitting can be deliberately pursued for individual payer revenue predictions. Observed payer revenue at a payer age of seven days can be considered to be a perfect prediction for an individual payer's revenue. Due to the nature of small sample size, in most cases, the average of payer revenue for all payers in one small cohort can differ from the average of payer revenue for all payers in another small cohort during another period of time. Although R₂ can be a better approximation of payer revenue, R₂ can be inferior to R₁ when the task is to estimate the cohort revenue per payer (e.g., at an age of seven days). Although current R₁ can be based on pre-install dimensions for a payer, R₁ can be applied to any other set of features, preferably by introducing an optimal amount of overfitting to the model, such that the average of R₁ can generalize well for the cohort.

In some instances, the user acquisition module 116 can be used to select one or more publishers for presenting items of content to prospective new users of the software application. The items of content can encourage the prospective users to download and install the software application. To present the items of content, the user acquisition module can provide bids to the publishers or other entities. The bids can be or include a price that a media buyer (e.g., a provider of the software application) is willing to pay for one or more items of content to be presented. For example, the media buyer may wish to bid on content presentations by a particular publisher. To determine a suitable bid price, the systems and methods described herein can attempt to determine a value associated with a cohort of users reached by the publisher. The cohort of users can be or include, for example, some or all users who downloaded and installed the software application in response to content presented by the publisher. Alternatively or additionally, the cohort of users can be or include a subset of these users who also live in a particular geographical location or have some other characteristic in common (e.g., device type, age, or gender).

The selected bid price in such an instance can be the predicted revenue for the cohort or some multiple thereof. For example, the selected bid price can be 20% lower than the predicted revenue, in an effort to achieve a desired return on investment (ROI). Additional logic, such as an ROI goal, an eCPM ceiling for a publisher, etc., can be applied to generate a final bid price. For publisher tier bidding, long-term cohort revenue (e.g., with publisher as a cohort or other cohorts containing publisher as a dimension) can be used as the 100% ROI click-per-install (CPI) bid price. Bid prices for other bid types, such as cost-per-click (CPC), can be calculated using an historical click-to-install ratio for the cohort. A suitable clustering algorithm can be applied for the cohort CPI, or any combinations of bid price for different bid type to generate the publisher tier. In some examples, the predicted payer probability and payer revenue can be written into a user-level table for publisher level bidding. Separate reports for publisher tier level bidding can be provided.

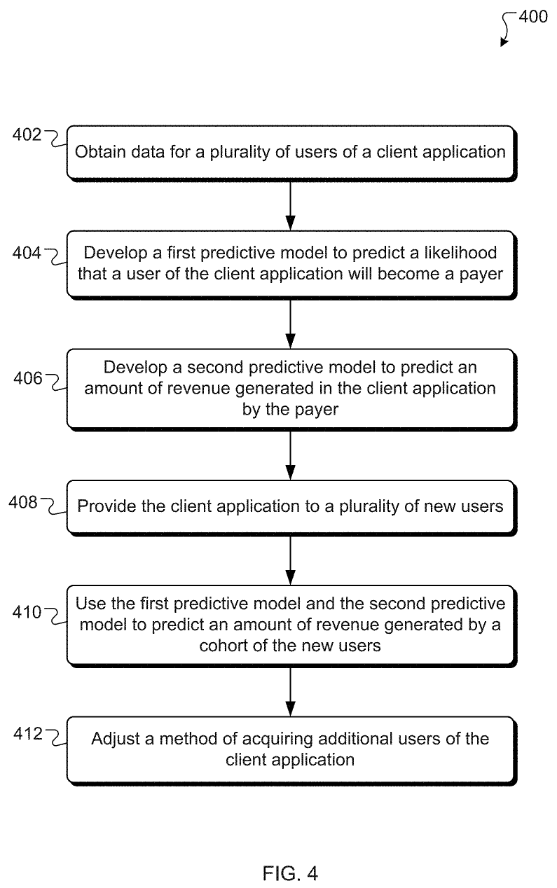

FIG. 4 illustrates an example computer-implemented method of determining values for user cohorts in a software application, such as a client application for a multiplayer online game. Data is obtained (step 402) for a plurality of users of a client application. Using the data, a first predictive model is developed (step 404) to predict a likelihood that a user of the client application will become a payer. Using the data, a second predictive model is developed (step 406) to predict an amount of revenue generated in the client application by the payer. The client application is provided (step 408) to a plurality of new users. The first predictive model and the second predictive model are used (step 410) to predict an amount of revenue generated by a cohort of the new users. Based on the predicted revenue for the cohort, a method of acquiring additional users of the client application is adjusted (step 412).

In various examples, the cohort value predictions described herein can be considered to be an average of modified user-level lifetime value (LTV) predictions that utilize underfitting deliberately. User engagement with a software application can be viewed as function of a set of key performance indicators (KPIs). In the context of a software application for an online game, for example, the KPIs can be or include features that span across various aspects or periods of time in a user's interactions with the online game. KPIs from a time prior to installation of the software application on the user's client device (e.g., referred to as pre-install features) can include, for example, campaign type (e.g., cost-per-click or cost-per-install) or time-to-install. After installation, the KPIs can include, for example, research power, play minutes, or other game features. The user engagement distribution within a small cohort (e.g., a subset of users from a cohort) can remain the same during a short time period and can serve as an approximation of the user engagement distribution of the entire cohort. The systems and methods can utilize value predictions for a small cohort to approximate the value of the entire cohort. Based on a binary classification methodology in which users can be classified as either payers or non-payers, a payer probability or payer ratio can be assigned to each cohort. Based on a regression analysis, the systems and methods can estimate an average revenue per payer for each cohort. Cohort value predictions can be updated in a timely fashion to allow new user acquisition methods to be adjusted in a timely fashion. For example, if a cohort of prospective new users is being targeted and the systems and methods indicate that such users will have a low value, the new user acquisition methods can be modified to avoid targeting such prospective new users.

To attract new users to an online game, prospective users can be presented with one or more items of content that describe the game, for example, in the form of text, images, sounds, and/or video. The prospective users can interact with the content and can be provided with opportunities to install the online game on their client devices. The prospective users can be identified or defined through demographic segmentation. Demographics can separate prospective users by indicators such as, for example, age, gender, education level, and/or income. Once the prospective users have been identified, one or more publishers (e.g., websites and/or other software applications) can be used to present the items of the content to the prospective users. Lifetime value predictions can be used to select the publishers and/or choose the specific items of content.

In particular, the systems and methods described herein can predict short-term user lifetime value (e.g., at a user age of 7 days) using a set of predictive models that receive various performance indicators or features as input. Some models can utilize a binary classification methodology, which can assign the probability of being a payer within, for example, 7 days (or other suitable time period) to each user. Based on regression analysis, the systems and methods can estimate the predicted revenue within, for example, 7 days for each user. Additionally or alternatively, the approach can utilize a fast feedback loop to incorporate or consider the most recent user behavior. For example, if a user did not make any purchases within 6 hours of install, a payer probability can be assigned. If the user also makes no purchases during the next 6 hours, the payer probability can be updated according to the user behavior during that time. The same can be applied to the day 7 revenue prediction as well. Thus, the systems and methods can adjust the short-term user lifetime predictions in a timely fashion to enable early and appropriate responsive action to be taken. Long-term multipliers, which can be differentiated by source (e.g., platform, publisher, geographical location, etc.), can be applied to generate long-term user lifetime value predictions.

In certain examples, the predictive models described herein can receive various types of processed data as input. The processed data can include, for example, pre-install features (e.g., from the pre-install data 130 database), application features (e.g., from the application data 132 database), and/or transaction features (e.g., from the transaction data 134 database). The pre-install features can include, for example, install platform (e.g., ANDROID or IOS), device model (e.g., IPHONE 8), device country code, Internet Protocol (IP) country code, and the like. Such features can capture a user profile from a time prior to installation of the software application. These features can be weighed more heavily for more recent installs (e.g., for users having a user age less than 2 or 3 days). The application features can include, for example, application accomplishments, application proficiency, and/or application usage. In the context of an online game, for example, the application features can include total power, user level, research complete, play minutes, game points or score, game assets, and the like. In general, once the software application has been installed, the application data can take over a user's original profile and/or can become the most important indicator of a user's future engagement in the game, as well as the propensity for the user to become a payer.

The quality or value of a user in digital marketing can be measured by the user's lifetime value (LTV). In some examples, the value of a user can be estimated by observing the user's short-term engagement and/or through the use of a user-level LTV model. Media buying, however, is generally done at a cohort level, where a cohort is a group of users sharing one or more common characteristics. For example, a cohort of users can be a group of users from the same country and/or from the same publisher (e.g., users who access content from the publisher).

In general, given a large marketing spend for some companies, the efficacy of marketing campaigns needs to be evaluated on a continuous basis. In light of the volume, velocity, and veracity of the marketing traffic, it is generally not practical or possible to assess the quality of a large number of cohorts manually. Advantageously, the cohort value prediction systems and methods described herein can leverage novel algorithms and big data platforms to extract actionable insights and help media buyers pause or cut down spend on low quality publishers, thereby allowing the media buyers to spend more on good quality publishers. An algorithmic-based system is particularly important owing to a constantly evolving nature of publishers and hence a need for cohort value prediction systems to auto-adapt regularly.

The ability of the systems and methods described herein to predict cohort value is important for several reasons. For example, in the mobile gaming context, users sharing similar in-game behavior might perform very differently in terms of revenue. Even the most engaged user can have less than a 30% chance of being a payer. Further, the amount of revenue generated by payers can vary significantly. In general, lifetime value predictions can be more accurate when more user data is used to make the predictions. For example, users with 6 hours of engagement data can generate more accurate predictions than with users with 4 hours of engagement data.

Further, cohort value prediction can be a prerequisite for creating marketing campaigns. Target audience(s) may need to be defined for a marketing campaign, for example, and one way to define a target audience is through geographic segmentation. Items of content (e.g., video or playable creatives) generally need to be selected for a marketing campaign. Such content can represent a core message of marketing and/or can encapsulate major themes to be communicated to a target audience. Once a target audience and content have been specified, a bid price for the campaign may need to be decided, for example, at the publisher or publisher tier level, according to the quality of the cohort. Moreover, when buying at the publisher tier level, cohort value in turn can affect the choice of which publishers belong to which tiers.

Additionally or alternatively, small cohort value can be subject to noise. At an individual user level, for example, an early-engaged user is generally more likely to be engaged in the long run. In the mobile gaming context, users who spend a lot of time playing are generally less likely to churn, more likely to pay, and hence can be considered high value. At the cohort level, the quality of a cohort can depend on the quality of new users coming from the same cohort. When trying to acquire new users from the same cohort, a media buyer (e.g., a provider of a software application) can hope that revenue generated by the acquired new users can help the media buyer break even with spend. Assuming the quality of a cohort does not change in a short period of time, the current and future users from the same cohort can be considered two different samples from the same population. Due to the nature of small sample size, it may be difficult to give accurate point estimates of cohort value from current users in the small cohort.

Further, early cohort value prediction is beneficial when using new publishers to present content to prospective users or when buying traffic from new sources. Historical revenue data of large publishers (e.g., websites or applications that have provided a large volume of new users for a certain period of time) may be provide a good indication of the quality of such publishers. For new publishers with little or no historical data, however, overbidding can bring low quality users to the software application, thereby potentially making return on investment (ROI) negative. In contrast, underbidding can fail to attract more users, thereby resulting in scaling issues. The sooner accurate cohort value predictions are available, the better new campaigns can be managed efficiently.

In some examples, user engagement with a software application can provide a good or best predictor of payer probability. For a mobile game business, revenue can be dominated by a relatively small number of very large payers or “whales.” While it may be tempting to try to predict these large payers, whales can be few and far between. Previous modeling attempts at predicting which new users will end up being whales have been mostly unsuccessful. A similar approach can be to treat this as a regression problem and try to predict the revenue per user; however, such an approach may not work very well given the skewed distribution of revenue. For example, the model may tend to be dominated by a small number of very large payers, and the model may not generalize well. Alternatively, models can focus more on events that are earlier in the funnel (e.g., shortly after installation of the software application), such as predicting payer probability. All whales are payers but there can be many more payers than whales.

Advantageously, as described herein, it can be much easier to predict payers than to predict whales. Once there is a payer prediction, as described herein, the payer prediction can be combined with a revenue per payer prediction. This can average out the effects of all payers and can more accurately account for the existence of whales, without being inaccurately skewed by whales. In general, there can be a lot more engaged users than paying users and the best predictor of paying users can be engagement.

With a software application, there can be many ways that engagement can be observed, such as minutes played or logged in, number of sessions, or level advancement. These engagement factors tend to be correlated with each other. User engagement can be observed shortly after installation of the software application, and this can be used as a predictor for payer probability from future installs that are similar. In some examples, to prevent the predictive models from being skewed by whales and/or to avoid inaccurate model predictions, the transaction data (e.g., in the transaction data 134 database) for whales can be adjusted to indicate that the whales were associated with a lower number of transactions or a lower amount of revenue. For example, the total amount of revenue for each user can be capped at a maximum value.

In various implementations, a goal of the systems and methods described herein may not be to predict the value of a specific user who has already installed; rather, the goal may be to predict the value of new users given specific targetable criteria such as publisher, country, device, etc. The predictive models can be created with inputs that are targetable criteria (e.g., on ad networks), such as publisher, country, and device type, along with early engagement metrics such as minutes played or level reached. The models can predict the probability of a user performing an in-app purchase within a short time period such as, for example, seven days or the like. This payer probability can be used to compute the value of the future installs. Additionally, the model-driven approach can arrive at a reasonable estimate of install value with far fewer installs than using descriptive statistics such as sample mean and confidence interval. For example, it may take as many as 500 installs to get a reasonable estimate of cohort value based on such statistical approaches. The cohort value models of the present invention, however, can arrive at an estimate with similar accuracy with as few as 50 installs. This can represent an order of magnitude reduction in cost required to assess the quality of a source of user installs. The systems and methods described herein can leverage evidence from all installs rather than only a cohort subset. Further, a final key insight is the use of long-term multipliers, which can be based on a linear model with a few targetable criteria. It can be impractical to predict long-term values directly because of lack of labels and recent data. On the other hand, there can be enough data for short-term observables, and a linear relationship between short-term value and long-term value can persist well at a cohort level.

To extract actionable insights from big data, it can be important to leverage big data technologies so that processing of large volumes of data can be supported. Big data technologies that can be used for the systems and methods described herein include, but are not limited to, APACHE PIG, APACHE HBASE, and APACHE HIVE. APACHE PIG is, in general, a platform for analyzing large sets of data that takes advantage of high-level language to express data analysis programs and includes infrastructure for evaluating these programs. APACHE HBASE is, in general, a column-oriented key/value data store built to run on top of the HADOOP Distributed File System (HDFS). APACHE HIVE is, in general, a data warehouse software project built on top of HADOOP for providing data summarization, query and analysis. APACHE HIVE can provide an SQL-like interface to query data stored in various databases and file systems that integrate with HADOOP. These big data technologies can be used as part of the processing module 120 and/or by other system components or modules.

The systems and methods described herein are designed in a modular fashion that is extensible for adding new algorithms or adding new data parameters or performance indicators as features. For example, as new forms of data related to users are developed and/or obtained, the systems and methods can utilize the new data to make lifetime value predictions. This allows new, impactful algorithms, and/or feature engineering to be developed and used by the systems and methods in an efficient and independent manner.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
obtaining data for a plurality of users of a client application;
developing, using the data, a first predictive model to predict a likelihood that a user of the client application will become a payer;
developing, using the data, a second predictive model to predict an amount of revenue generated in the client application by the payer;
providing the client application to a plurality of new users;
using the first predictive model and the second predictive model to predict an amount of revenue generated by a cohort of the new users; and
adjusting, based on the predicted revenue for the cohort, a method of acquiring additional users of the client application.

2. The method of claim 1, wherein the data comprises a record of user activity from before or after installation of the client application.

3. The method of claim 1, wherein the data comprises at least one of a user characteristic or a client device characteristic.

4. The method of claim 1, wherein the client application comprises a multiplayer online game.

5. The method of claim 1, wherein using the first predictive model comprises:
providing, as input to the first predictive model, one or more features for each new user in the plurality of new users,
wherein the one or more features comprise an indication of the new user's activity from before or after the new user began using the client application; and
receiving, as output from the first predictive model, a predicted likelihood that each new user will be a payer in the client application.

6. The method of claim 1, wherein using the second predictive model comprises:
providing, as input to the second predictive model, one or more features for each new user in the plurality of new users,
wherein the one or more features for each new user comprise an indication of the new user's activity from before or after the new user began using the client application; and
receiving, as output from the second predictive model, a predicted amount of revenue generated by each new user who becomes a payer in the client application.

7. The method of claim 1, wherein using the first predictive model and the second predictive model comprises:
combining predictions from the first predictive model and the second predictive model to predict an amount of revenue generated by each new user who becomes a payer in the client application;
identifying from among the plurality of new users a subset of new users who belong to the cohort; and
determining a total predicted revenue generated by the subset of new users.

8. The method of claim 1, wherein the predicted amount of revenue generated by the cohort comprises a prediction for an initial time after the cohort began using the client application.

9. The method of claim 8, wherein using the first predictive model and the second predictive model comprises:
extrapolating the prediction for the initial time to a later time using one or more multipliers.

10. The method of claim 1, wherein the method of acquiring additional users comprises presenting content related to the client application to a set of prospective additional users.

11. A system, comprising:
one or more computer processors programmed to perform operations comprising:
obtaining data for a plurality of users of a client application;
developing, using the data, a first predictive model to predict a likelihood that a user of the client application will become a payer;
developing, using the data, a second predictive model to predict an amount of revenue generated in the client application by the payer;
providing the client application to a plurality of new users;
using the first predictive model and the second predictive model to predict an amount of revenue generated by a cohort of the new users; and
adjusting, based on the predicted revenue for the cohort, a method of acquiring additional users of the client application.

12. The system of claim 11, wherein the data comprises a record of user activity from before or after installation of the client application.

13. The system of claim 11, wherein the client application comprises a multiplayer online game.

14. The system of claim 11, wherein using the first predictive model comprises:
providing, as input to the first predictive model, one or more features for each new user in the plurality of new users,
wherein the one or more features comprise an indication of the new user's activity from before or after the new user began using the client application; and
receiving, as output from the first predictive model, a predicted likelihood that each new user will be a payer in the client application.

15. The system of claim 11, wherein using the second predictive model comprises:
providing, as input to the second predictive model, one or more features for each new user in the plurality of new users,
wherein the one or more features for each new user comprise an indication of the new user's activity from before or after the new user began using the client application; and
receiving, as output from the second predictive model, a predicted amount of revenue generated by each new user who becomes a payer in the client application.

16. The system of claim 11, wherein using the first predictive model and the second predictive model comprises:
combining predictions from the first predictive model and the second predictive model to predict an amount of revenue generated by each new user who becomes a payer in the client application;
identifying from among the plurality of new users a subset of new users who belong to the cohort; and
determining a total predicted revenue generated by the subset of new users.

17. The system of claim 11, wherein the predicted amount of revenue generated by the cohort comprises a prediction for an initial time after the cohort began using the client application.

18. The system of claim 17, wherein using the first predictive model and the second predictive model comprises:
extrapolating the prediction for the initial time to a later time using one or more multipliers.

19. The system of claim 11, wherein the method of acquiring additional users comprises presenting content related to the client application to a set of prospective additional users.

20. An article, comprising:
a non-transitory computer-readable medium having instructions stored thereon that, when executed by one or more computer processors, cause the one or more computer processors to perform operations comprising:
obtaining data for a plurality of users of a client application;
developing, using the data, a first predictive model to predict a likelihood that a user of the client application will become a payer;
developing, using the data, a second predictive model to predict an amount of revenue generated in the client application by the payer;
providing the client application to a plurality of new users;
using the first predictive model and the second predictive model to predict an amount of revenue generated by a cohort of the new users; and
adjusting, based on the predicted revenue for the cohort, a method of acquiring additional users of the client application.
